(19) United States
(12) Patent Application Publication
(10) Pub. No.: US 2018/0252013 A1
(43) Pub. Date: Sep. 6, 2018

(54) DETACHABLE HINGE ASSEMBLY

(71) Applicant: Suncast Technologies, LLC, Palm Beach Gardens, FL (US)

(72) Inventors: William J. Phillips, Batavia, IL (US); Dov Blitzer, Naperville, IL (US); Michael Thuma, La Grange, IL (US)

(21) Appl. No.: 15/784,860

(22) Filed: Oct. 16, 2017

Related U.S. Application Data
(63) Continuation-in-part of application No. 29/595,703, filed on Mar. 1, 2017.

(51) Int. Cl. E05D 7/10; E05D 5/00; B65D 43/16; B65D 81/38

(52) U.S. Cl. CPC E05D 7/1005; E05D 5/00; B65D 43/165; E05D 2007/1027; E05Y 2900/602; E05Y 2600/60; B65D 81/3825

(57) ABSTRACT

The disclosed invention is a detachable hinge assembly, which, in one embodiment, can be employed on a cooler to provide a cooler with a removable lid. The hinge assembly includes a first attachment bar and second attachment bar coupled to the cooler body and lid, respectively, and are connected through a releasable hinge assembly which pivotably couples to both the first and second attachment bars. The releasable hinges each have an end flange constructed to pivotably couple to the first and second attachment bars and a projection having both a clip and a receiving portion. The clip from each projection is adapted to releasably couple to the receiving portion of the corresponding projection.

### PRIORITY CLAIM

In accordance with 37 C.F.R. 1.76, a claim of priority is included in an Application Data Sheet filed concurrently herewith. Accordingly, the present invention claims priority under 35 U.S.C. §§ 119(e), 120, 121, and/or 365(c) to U.S. Design Patent Application No. 29,595,703, entitled “Cooler”, filed Mar. 1, 2017, The contents of the above referenced application are incorporated herein by reference in its entirety.

### FIELD OF THE INVENTION

This invention relates generally to hinges, and in particular, to a hinge allowing for quick detachment of the hinged pieces, which is especially useful for coolers.

### BACKGROUND OF THE INVENTION

Hinges are well-known in the art, and are found in common everyday items, as well as in highly complex devices. In simple terms, a hinge is a mechanical device for connecting two solid objects, allowing for limited rotation of the objects relative to each other. In one of the most common hinge designs, the barrel hinge found commonly on household and office doors, two plates are each pivotably coupled to a central barrel pivot. The plates are secured to both the door and the doorframe to allow the door to pivot relative to the fixed barrel.

Double-shaft hinges have also been used, when joining two pieces, in a way to minimize the excess space used by the hinge and allow the two pieces to fit more flush together. An example of a double-shaft hinge used in a laptop can be seen in U.S. Pat. No. 9,611,680.

Lift-off hinges allow the two connected pieces to be easily removed from each other. These are more common in furniture. With a lift-off hinge, there is still the typical structure of a barrel hinge, i.e., two plates pivotally attached to a barrel pivot. The difference is that, by moving the plates in opposite directions along the axis of the barrel pivot, the two pieces disconnect. A problem associated with these hinges is bending or breakage related to storage of the disconnected parts. This construction leaves delicate portions of the hinge components vulnerable to the weight of the cooler parts during movement or storage.

However, there still exists a need in the art for a detachable hinge that allows two pieces to connect, such as a cooler and lid, in a manner that allows for quick detachment of the two pieces without requiring any permanent structural attachment of any of the pieces.

### SUMMARY OF THE INVENTION

The present invention provides a detachable hinge assembly. More specifically, the present invention provides a detachable hinge assembly that overcomes the deficiencies of the prior art by providing a two-piece hinge construction having integrally formed snap connectors that attach to the two objects being pivotably connected without additional fasteners or the requirement of tools for assembly or disassembly. The two like constructed hinge members of the hinge assembly are releasably secured to one another with a ramp or snap lock. A flange provided at the distal end of each hinge member is provided with means for pivotally connecting to objects, such as a cooler body and lid. The two hinge members each include a short shaft, including both a clip and a clip receiving portion to receive a corresponding clip from the second hinge member. The short shafts are positioned coaxially and facing each other so that a portion of one short shaft can interlock with the other. This allows the two hinge member pieces to removably attach to each other and maintain the functionality of the hinge with respect to the objects hingedly connected (such as a cooler and lid). The flanges may be provided with bearings or stub shafts, or the like, for connection to the cooler body and lid, which allow rotation of each with respect to the hinge assembly. When the hinge pieces are disconnected, each hinge member can be removed from the object (e.g., cooler and lid) by disconnecting the snap lock and sliding the hinge members off of the stub shafts and/or bearing surfaces.

Accordingly, it is a primary objective of the present invention to provide a hinge assembly which can pivotably attach two objects.

It is a further objective of the present invention to provide a hinge assembly which can be quickly disassembled and removed from the objects that it is connecting.

It is yet another objective of the present invention to provide a cooler with a removably attached lid.

It is further an objective of the present invention to provide a hinge assembly which can be quickly and easily connected or disconnected.

It is a still further objective of the present invention to provide a hinge assembly where the two halves of the hinge are identical so that corresponding attachment portions align when the two pieces are connected.

Other objects and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a perspective view of a cooler employing the detachable hinge assembly to provide a removable lid to the cooler;

FIG. 2 is a back view of the cooler of FIG. 1;

FIG. 3 is a right-side view of the cooler of FIG. 1;

FIG. 4 is a front view of the cooler of FIG. 1;

FIG. 5 is a top view of the cooler of FIG. 1;

FIG. 6 is an exploded view of the cooler of FIG. 1 employing a removable inner cooler receptacle;

FIG. 7 is a cross-sectional view of the cooler of FIG. 8 taken along line 7-7 of FIG. 8;

FIG. 8 is a back view of the cooler of FIG. 6;

FIG. 9 is a top view of one detachable hinge member;

FIG. 10 is a side view of the detachable hinge member of FIG. 9;

FIG. 11 is a rear perspective view of the detachable hinge member of FIG. 9;

FIG. 12 is an end view of the detachable hinge member of FIG. 9;

FIG. 13 is a perspective view of one embodiment of a cooler employing the detachable hinge assembly; and

FIG. 14 is a partial exploded view taken along lines 14-14 of FIG. 13 illustrating assembly of the detachable hinge members.

### DETAILED DESCRIPTION OF THE INVENTION

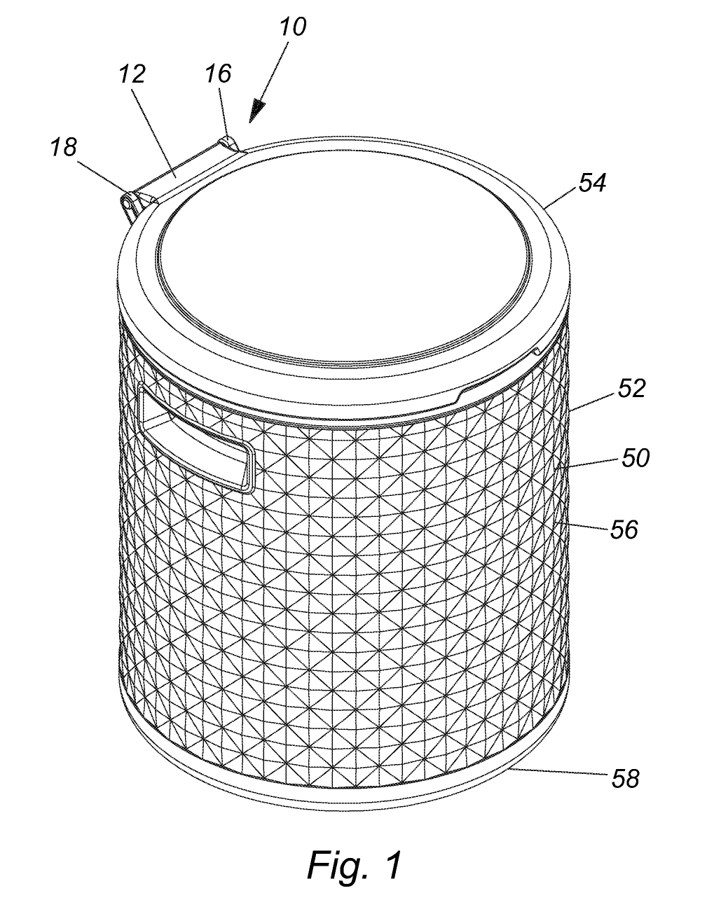

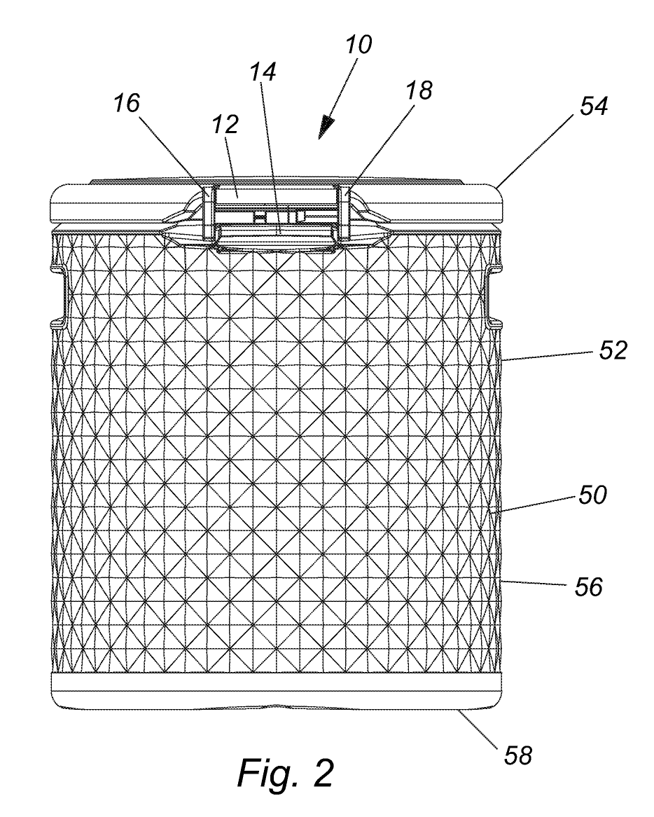

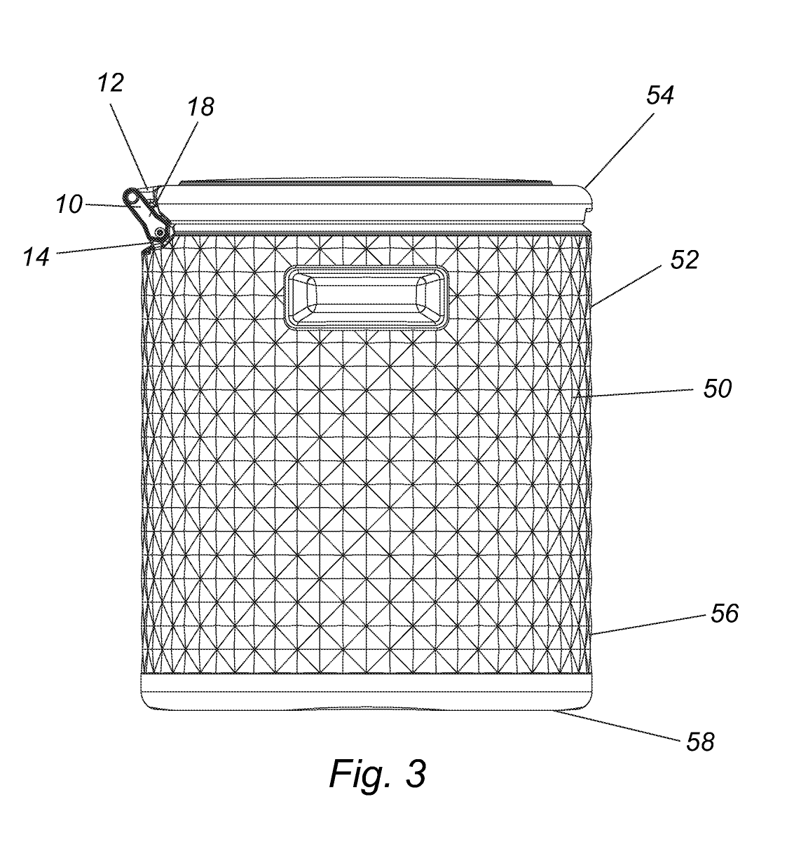

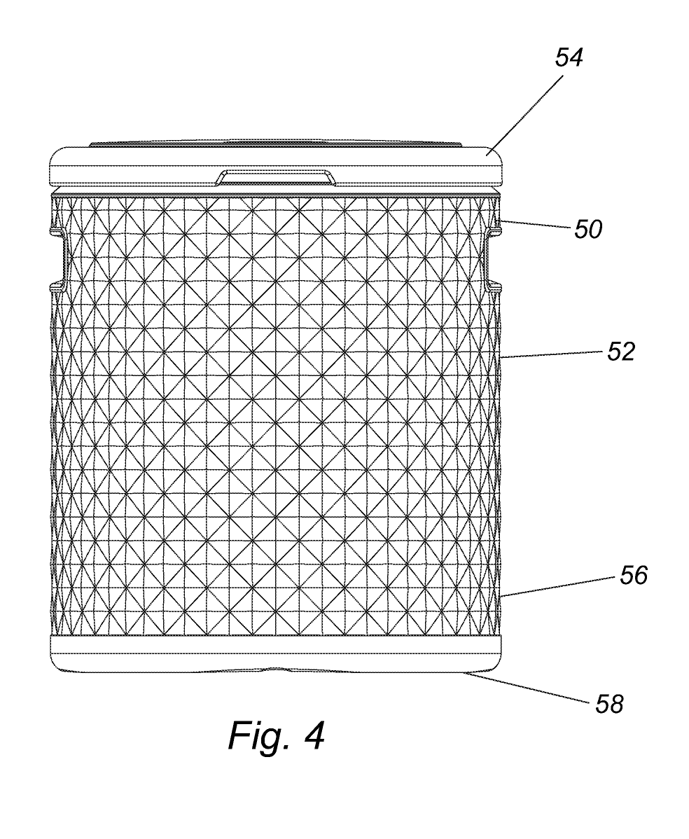

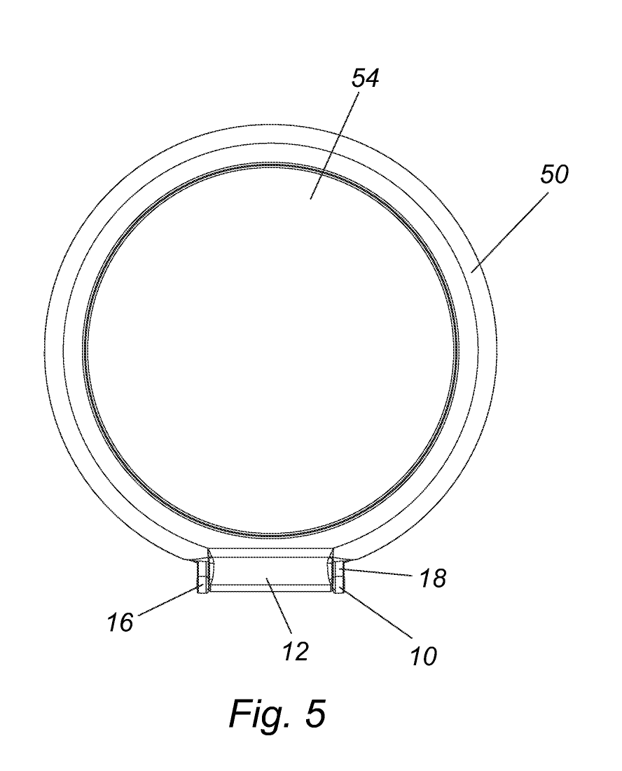

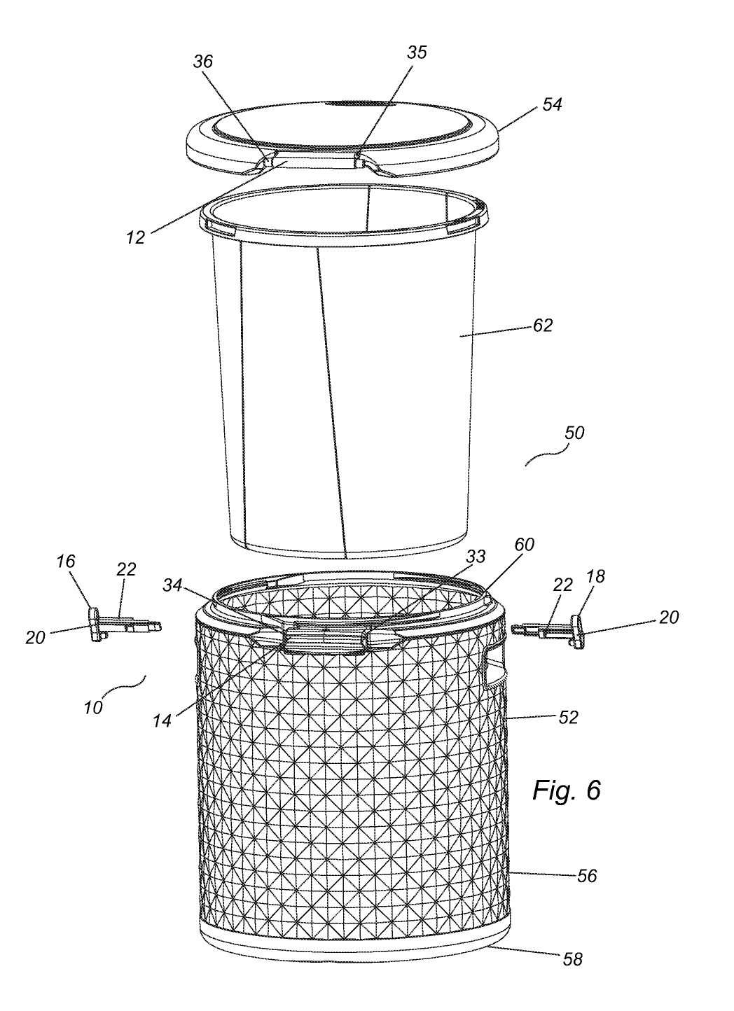

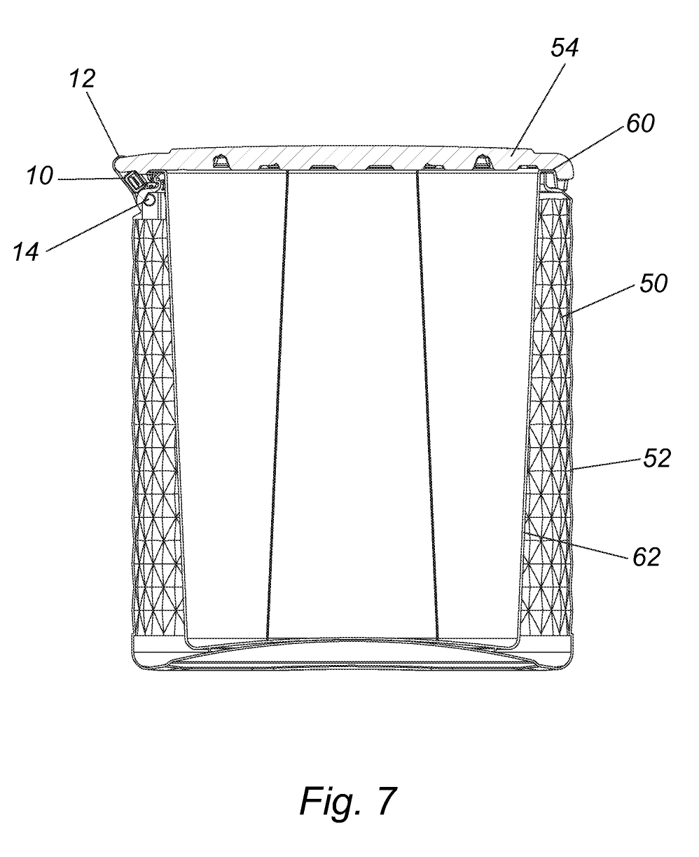

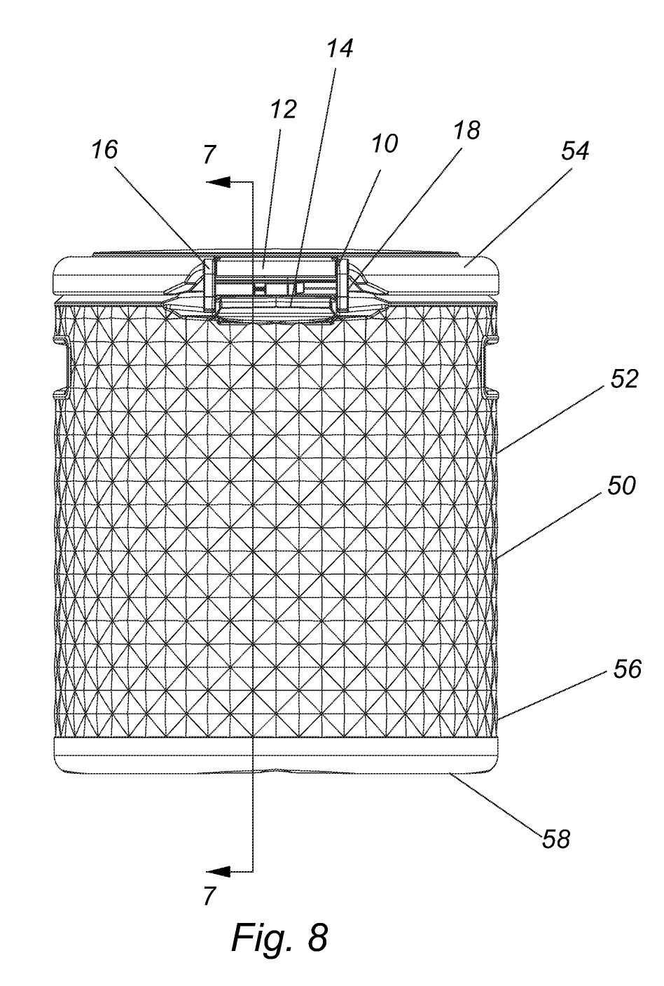

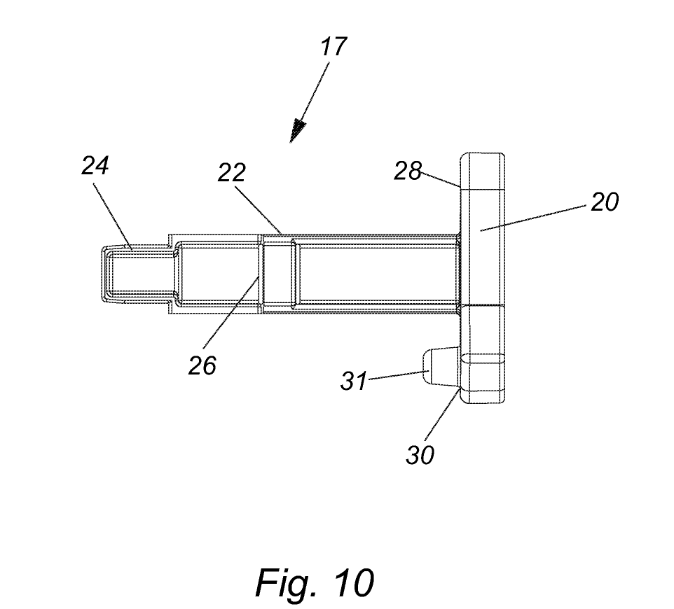

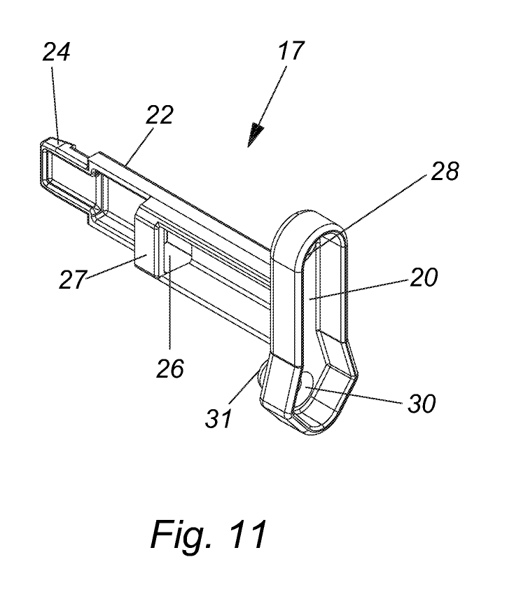

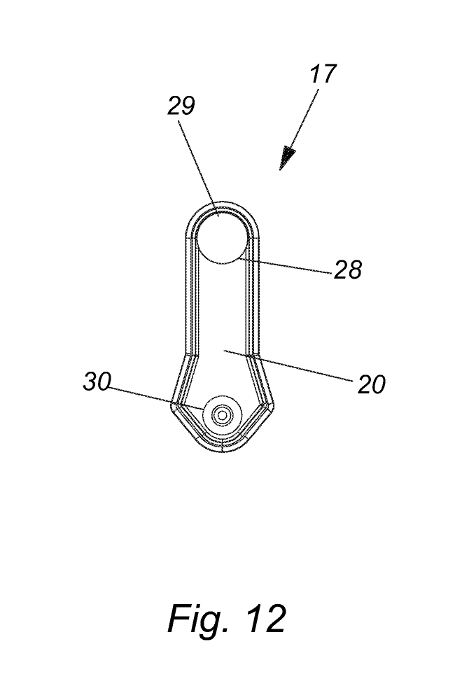

Referring to FIGS. 1-14, one embodiment of the detachable hinge assembly 10 of the present invention is illustrated. In one embodiment, the detachable hinge assembly 10 is employed on a cooler 50. However, the hinge 10 is not restricted to use with a cooler 50; and, in fact, can be employed anywhere a quick-release detachable hinge is useful.

As shown in FIGS. 1-8 and 13, a cooler 50 has a body 52 connected to a lid 54 through a detachable hinge assembly 10. The cooler body 52 has a perimeter sidewall 56 and a bottom wall 58. The perimeter sidewall 56 extends from the bottom wall 58 to an upper rim 60, which forms an opening into the body of the cooler 50. The cooler lid 54 engages the upper rim 60 to seal the cooler 50. The cooler lid 54 is removably attached to the cooler 50 through the detachable hinge assembly 10. The cooler 50 can also include an inner receptacle 62, such as a liner, to help insulate articles placed inside of the cooler 50.

The detachable hinge assembly 10 includes a first attachment bar 14 coupled to the cooler 50 and a second attachment bar 12 coupled to the cooler lid 54. As shown in the embodiment illustrated in FIGS. 1-14 the first attachment bar 14 is formed as part of the upper rim 60; however, in alternate embodiments, the attachment bar 14 can be a separate piece that is coupled to the rim 60. Also shown in this embodiment is the second attachment bar 12, which is formed integrally with the coolerlid 54 on a perimeter of the lid 54; but again, in alternate embodiments, the attachment bar 12 can be a separate piece that is coupled to the perimeter of the lid 54. The first attachment bar 14 has a first end 33 and a second end 34. The second attachment bar 12 has a first end 35 and a second end 36.

The detachable hinge assembly 10 allows the lid 54 to be pivotably coupled to the cooler body 52 through the first attachment bar 14 and second attachment bar 12. The first attachment bar 14 is coupled to the second attachment bar 12 through a first hinge member 16 and a second hinge member 18. As shown in the figures, in a preferred embodiment, the first and second hinge members 16, 18 can be constructed the same to reduce the number of unique pieces required for the construction.

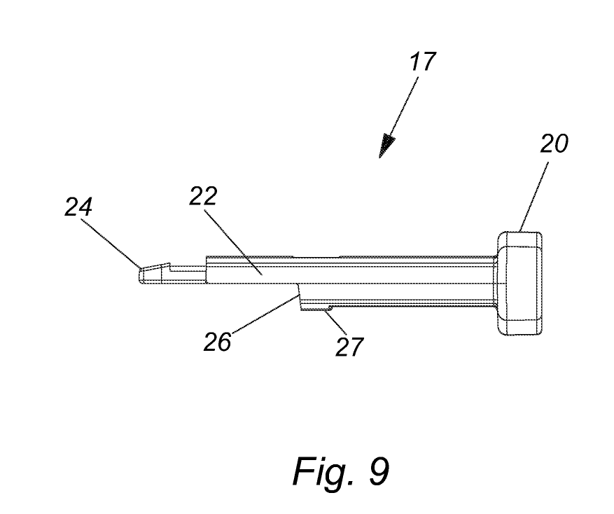

FIGS. 9-12 illustrate a preferred embodiment of the hinge member 17, which can be used as both the first hinge member 16 and the second hinge member 18. As shown, the hinge member 17 includes an end flange 20 and an attachment projection 22 extending from the inner surface of the end flange 20. The projection 22 is designed to releasably couple to a corresponding projection 22 on a second hinge member 17. The projection 22 includes an insertion clip 24 and a receiving portion 26, where the snap or ramp lock 24 is on one half of the projection 22 and the receiving portion 26 is on a second half of the projection 22. When two hinge members 17 engage with each other, the insertion clip 24 of the first projection 22 inserts into the receiving portion 26 of the second hinge member 17, and vice versa, allowing the snap locks to releasably engage a catch 27 integrally formed on the projection.

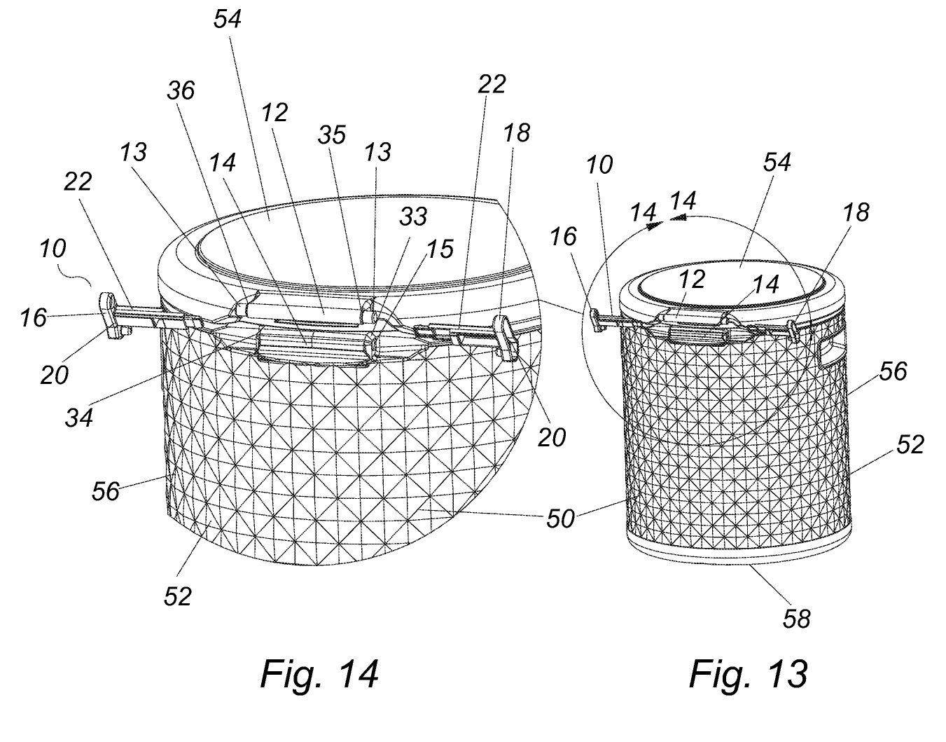

The hinge member 17 also includes a first attachment region 30 and a second attachment region 28 on the end flange 20. The first and second attachment regions 30, 28 are constructed to be able to pivotably couple to the first and second attachment bars 14, 12, respectively. In the hinge member shown in FIGS. 9-12, the first attachment region 30 includes an attachment pin 31, such as an axle, stub shaft or other generally cylindrical projection, to pivotably couple with a corresponding attachment aperture recess 15 located at the distal ends of the first attachment bar 14, as shown in FIG. 13, and the second attachment region 28 includes a generally cylindrical aperture 29 to pivotably couple with a corresponding attachment shaft 13, such as an axle, on the second attachment bar 12. In these embodiments, generally cylindrical refers to any shape that would allow rotation of the attachment bars with respect to the hinge.

It should be noted, however, that the first and second attachment regions 30, 28 can include an attachment rod or an aperture, so long as the first and second attachment bars 14, 12 include the corresponding structure to allow the first and second attachment regions 30, 28 to pivotably couple to the first and second attachment bars 14, 12. For example, the first and second attachment regions 30, 28 could each include an attachment portion, such as an axle, so long as both the first attachment bar 14 and second attachment bar 12 included an attachment aperture recess 15 at the end. Conversely, the first and second attachment regions 30, 28 could both include an aperture to connect to attachment axles on the ends of the first and second attachment bars 14, 12. The hinge assembly 10 could also include any combination thereof between the hinge member 17 and the attachment bars 14, 12. It should also be noted that the present device allows, although does not require, each attachment bar to be formed as a single piece through the process of injection molding, or the like, to minimize components of the assembly.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A detachable hinge comprising:
a first attachment bar, said first attachment bar having a first end, a second end, and a length;
a second attachment bar, said second attachment bar having a first end, a second end, and a length, said second attachment bar adapted to be pivotably coupled to said first attachment bar;
a releasable hinge assembly adapted to be releasably coupled to said first attachment bar and said second attachment bar, said releasable hinge assembly adapted to be pivotably coupled to said first attachment projection and said second attachment projection, said releasable hinge assembly having a first hinge member and a second hinge member, said first hinge member having a first end flange and a first attachment projection, said first end flange having an inner surface, said first attachment projection coupled to said first end flange inner surface, said second hinge member having a second end flange and a second attachment projection, said second end flange having an inner surface, said second attachment projection coupled to said second end flange inner surface, said first attachment projection adapted to releasably couple to said second attachment projection.

2. The detachable hinge of claim 1, wherein said first attachment bar is coupled to a first member, and said second attachment bar is coupled to a second member.

3. The detachable hinge of claim 1, wherein said first attachment bar is integrally coupled to a first member and said second attachment bar is integrally coupled to a second member.

4. The detachable hinge of claim 1, wherein said first attachment bar first end is constructed and arranged to pivotably couple to said first end flange inner surface, said first attachment bar second end is constructed and arranged to pivotably couple to said second end flange inner surface, said second attachment bar first end is constructed and arranged to pivotably couple to said first end flange inner surface, said second attachment bar second end is constructed and arranged to pivotably couple to said second end flange inner surface.

5. The detachable hinge of claim 4, wherein said first attachment projection has an insertion clip and a receiving portion, said second attachment projection has an insertion clip and a receiving portion, said first attachment projection insertion clip constructed and arranged to secure to said second attachment projection receiving portion, said second attachment projection insertion clip constructed and arranged to secure to said first attachment projection receiving portion.

6. The detachable hinge of claim 4, wherein said first end flange includes a first aperture adapted to receive an axle projection, said axle projection coupled to said first attachment bar first end.

7. The detachable hinge of claim 6, wherein said second end flange includes a first aperture adapted to receive an axle projection, said axle projection coupled to said first attachment bar second end.

8. The detachable hinge of claim 4, wherein said first attachment bar first end includes a first receiving portion, said first end flange includes an axle projection adapted to pivotably couple to said first attachment bar first receiving portion.

9. The detachable hinge of claim 8, wherein said first attachment bar second end includes a second receiving portion, said second end wall includes an axle projection adapted to pivotably couple to said first attachment bar second receiving portion.

10. A cooler with a hinge for a removable lid comprising:
a cooler body, said cooler body having a bottom wall, said bottom wall having a perimeter, said cooler having a body sidewall extending from said bottom wall perimeter to an upper end, said body sidewall upper end forming an upper rim;
a cooler lid, said cooler lid having a perimeter, said cooler lid perimeter constricted and arranged to removeably attach to said cooler body upper rim;
a first attachment bar coupled to said cooler body upper rim, said first attachment bar having a first end, a second end, and a length;
a second attachment bar coupled to said cooler lid perimeter, said second attachment bar having a first end, a second end, and a length, said second attachment bar adapted to be pivotably coupled to said first attachment bar;
a releasable hinge assembly adapted to be releasably coupled to said first attachment bar and said second attachment bar, said releasable hinge assembly adapted to be pivotably coupled to said first attachment member and said second attachment member, said releasable hinge assembly having a first hinge member and a second hinge member, said first hinge member having a first end wall and a first attachment projection, said first end wall having an inner surface, said first attachment projection coupled to said first end flange inner surface, said second hinge member having a second end flange and a second attachment projection, said second end flange having an inner surface, said second attachment projection coupled to said second end flange inner surface, said first attachment projection adapted to releasably couple to said second attachment projection.

11. The detachable hinge of claim 10, wherein said first attachment bar is formed integrally to said cooler body upper rim and said second attachment bar is formed integrally coupled to said cooler lid perimeter.

12. The detachable hinge of claim 10, wherein said first attachment bar first end is constructed and arranged to pivotably couple to said first end flange inner surface, said first attachment bar second end is constructed and arranged to pivotably couple to said second end flange inner surface, said second attachment bar first end is constructed and arranged to pivotably couple to said first end flange inner surface, said second attachment bar second end is constructed and arranged to pivotably couple to said second end flange inner surface.

13. The detachable hinge of claim 12, wherein said first attachment projection has an insertion clip and a receiving portion, said second attachment projection has an insertion clip and a receiving portion, said first attachment projection insertion clip constructed and arranged to secure to said second attachment projection receiving portion, said second attachment projection insertion clip constructed and arranged to secure to said first attachment projection receiving portion.

14. The detachable hinge of claim 12, wherein said first end flange includes a first aperture adapted to receive an axle projection, said axle projection coupled to said first attachment bar first end.

15. The detachable hinge of claim 14, wherein said second end flange includes a first aperture adapted to receive an axle projection, said axle projection coupled to said first attachment bar second end.

16. The detachable hinge of claim 12, wherein said first attachment bar first end includes a first receiving portion, said first end flange includes an axle projection adapted to pivotably couple to said first attachment bar first receiving portion.

17. The detachable hinge of claim 16, wherein said first attachment bar second end includes a second receiving portion, said second end flange includes an axle projection adapted to pivotably couple to said first attachment bar second receiving portion.

18. The detachable hinge of claim 10, further including an inner receptacle, said inner receptacle constructed to be contained within said cooler body sidewall, said inner receptacle having an upper lip, said inner receptacle upper lip constructed and arranged to connect to said cooler body upper rim.
